(19) United States
(12) Patent Application Publication
(10) Pub. No.: US 2026/0320288 A1
(43) Pub. Date: Oct. 15, 2026

(54) SYSTEM AND METHOD FOR USE OF SPREADSHEETS INTEGRATED WITH WEB SERVICES, INCLUDING SUPPORT FOR CREATION OF CHILD ROWS

(71) Applicant: ORACLE INTERNATIONAL CORPORATION, Redwood Shores, CA (US)

(72) Inventors: Xiameng Chen, Sunnyvale, CA (US); Edmund Alex Davis, San Mateo, CA (US)

(21) Appl. No.: 19/177,949

(22) Filed: Apr. 14, 2025

(51) Int. Cl. G06F 40/18; G06F 3/0482; G06F 3/04845; G06F 9/54

(52) U.S. Cl. CPC G06F 40/18; G06F 3/0482; G06F 3/04845; G06F 9/547

(57) ABSTRACT

A system and method for use of spreadsheets integrated with web services, including support for creation of child rows in child spreadsheets. A client device can interrogate one or more web services to obtain web service metadata that determines one or more capabilities of those web services. This metadata can be used to automatically configure an editable table component in a spreadsheet. The table component can be used to retrieve data, edit that data in a spreadsheet, and upload changes back to a web service, or provide validations, recommendations, or other functionalities. A user interface allows a user to create child layouts, including inputting a number of child rows to be created for selected parent layout or rows. The system then activates a child layout with appended child rows, including automatically selecting the first editable cell in the first child row and populating ancestor values indicative of the hierarchical relationship.

### CROSS-REFERENCE TO RELATED APPLICATIONS

The present application is related to U.S. Patent Application titled “ORCHESTRATION OF CRUD OPERATIONS FOR A HIERARCHICAL WEB SERVICE DATA MODEL IN A SPREADSHEET”, application Ser. No. 17/008,503, filed Aug. 31, 2020, and subsequently issued as U.S. Pat. No. 11,556,702 on Jan. 17, 2023; and U.S. Patent Application titled “ABILITY TO ADD NON-DIRECT ANCESTOR COLUMNS IN CHILD SPREADSHEETS”, application Ser. No. 17/876,327, filed Jul. 28, 2022, and subsequently issued as U.S. Pat. No. 12,260,170 on Mar. 25, 2025; each of which above patent applications and patents, together with the contents thereof, are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to software application development, and are particularly directed to a system and method for use of spreadsheets integrated with web services, including support for creation of child rows in child spreadsheets.

### BACKGROUND

Software-based spreadsheets are a popular tool by which business users can access, update, and analyze their business data. Some integrated environments allow the use of a spreadsheet to access enterprise data or information via business objects accessible via web services.

Such business objects can be associated with various parent-child relationships, allowing the user to create dependent layouts, and then perform operations, such as downloading data or uploading changes, on several layouts of spreadsheet rows.

However, the process for creating child rows in such environments is often complicated and tedious, typically requiring the user to examine each child layout, check if the child layout can create child rows, insert new rows on the child layout manually, and switch back-and-forth between a parent layout and the child layout to insert ancestor values indicative of the hierarchical relationship.

Such a process generally requires the user to retain within their memory several spreadsheet values, spanning multiple layouts, and can result in errors. For example, if any ancestor value is wrong, the child row creation will fail.

### SUMMARY

In accordance with various embodiments, described herein is a system and method for use of spreadsheets integrated with web services, including support for creation of child rows in child spreadsheets.

A client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

A user interface allows a user to create child layouts, including inputting a number of child rows to be created for selected parent layouts or rows. The system then activates a child layout with appended child rows, including automatically selecting the first editable cell in the first child row and populating ancestor values indicative of the hierarchical relationship.

### BRIEF DESCRIPTION OF THE DRAWINGS

FIG. 1 illustrates a system for use of spreadsheets integrated with web services, in accordance with an embodiment.

FIG. 2 further illustrates a system for use of spreadsheets integrated with web services, in accordance with an embodiment.

FIG. 3 further illustrates a system for use of spreadsheets integrated with web services, in accordance with an embodiment.

FIG. 4 illustrates an example business object hierarchy, in accordance with an embodiment.

FIG. 5 illustrates a system for creation of child rows in child spreadsheets, in accordance with an embodiment.

FIG. 6 further illustrates a system for creation of child rows in child spreadsheets, in accordance with an embodiment.

FIG. 7 further illustrates a system for creation of child rows in child spreadsheets, in accordance with an embodiment.

FIG. 8 illustrates an example use of the system to create child rows in child spreadsheets, in accordance with an embodiment.

FIG. 9 further illustrates an example use of the system to create child rows in child spreadsheets, in accordance with an embodiment.

FIG. 10 further illustrates an example use of the system to create child rows in child spreadsheets, in accordance with an embodiment.

FIG. 11 further illustrates an example use of the system to create child rows in child spreadsheets, in accordance with an embodiment.

FIG. 12 further illustrates an example use of the system to create child rows in child spreadsheets, in accordance with an embodiment.

FIG. 13 further illustrates an example use of the system to create child rows in child spreadsheets, in accordance with an embodiment.

FIG. 14 illustrates a process for creation of child rows, in accordance with an embodiment.

### DETAILED DESCRIPTION

Software-based spreadsheets are a popular tool by which business users can access, update, and analyze their business data. Some integrated environments allow the use of a spreadsheet to access enterprise data or information via business objects accessible via web services.

Such business objects can be associated with various parent-child relationships, allowing the user to create dependent layouts, and then perform operations, such as downloading data or uploading changes, on several layouts of spreadsheet rows.

However, the process for creating child rows in such environments is often complicated and tedious, typically requiring the user to examine each child layout, check if the child layout can create child rows, insert new rows on the child layout manually, and switch back-and-forth between a parent layout and the child layout to insert ancestor values indicative of the hierarchical relationship.

Such a process generally requires the user to retain within their memory several spreadsheet values, spanning multiple layouts, and can result in errors.

In accordance with various embodiments, described herein is a system and method for use of spreadsheets integrated with web services, including support for creation of child rows in child spreadsheets.

A client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

A user interface allows a user to create child layouts, including inputting a number of child rows to be created for selected parent layout or rows. The system then activates a child layout with appended child rows, including automatically selecting the first editable cell in the first child row and populating ancestor values indicative of the hierarchical relationship.

For the purposes of the present discussion, a server may be any computing resource, such as a computer and/or software that is adapted to provide content, e.g., data and/or functionality, to another computing resource or entity that requests it, i.e., the client. A client may be any computer or system, including software system that is adapted to receive content from another computer or system, called a server. A server system may be any collection of one or more servers and accompanying computing resources. The terms “client device” and “client” may be employed interchangeably herein, however, depending upon the context in which the term is used, the term client may refer more generally to both client devices and client software.

A computing environment may be any collection of computing resources used to perform one or more tasks involving computer processing. A computer may be any processor in communication with a memory. A computing resource may be any component, mechanism, or capability or quantities thereof of a computing environment, including, but not limited to, processors, memories, software applications, user input devices, and output devices, servers, and so on. Examples of computing resources include data and/or software functionality offered by one or more web services, Application Programming Interfaces (APIs), etc.

An enterprise computing environment may be any computing environment used for a business or organization. An example enterprise computing environment includes various computing resources distributed across a network and may further include private and shared content on Intranet Web servers, databases, files on local hard discs or file servers, email systems, document management systems, portals, and so on.

A given software application may include (but not necessarily) constituent software applications or modules (e.g., services, functions, procedures, computing objects, etc.). Accordingly, the term “software application” may also include networked software applications or integrated groups thereof.

For the purposes of the present discussion, a software system may be any collection of computing resources implementing machine-readable instructions, i.e., computer code. Accordingly, the term “software system” may refer to a software application, and depending upon the context in which the term is used, may further refer to the accompanying computer(s) and associated computing resources used to run the software application.

Depending upon the context in which the term is used, a software system may further include hardware, firmware, and other computing resources enabling running of the software application. Note that certain software systems may include collections of disparate services, which are implemented in particular sequences in accordance with a process template and accompanying logic. Accordingly, the terms “software system,” “system,” and “software application” may be employed interchangeably herein to refer to modules or groups of modules or computing resources used for computer processing.

For the purposes of the present discussion, a web service may be any computer code and associated functionality that is adapted to be called by an application or other service or process whose code is stored in a separate location (e.g., on another computer or memory storage location or device) from the web service. Accordingly, the term “service” as used herein is relatively broad and may include remotely accessible APIs and services characterized by Web Services Description Language (WSDL) interfaces, Simple Object Access Protocol (SOAP), REpresentational State Transfer (REST), YAML (Yet Another Markup Language), and/or other types of interfaces.

Generally, web services, also simply called services herein, provide functionality, e.g., capabilities, that may be reused by different applications, processes, or web services (that may be distributed across a network), which access the functionality via a service interface (e.g., WSDL interface) consistent with a description of the web service. A web services model may represent a loosely coupled integration model for allowing flexible integration of various network-distributed applications or processes.

Embodiments discussed herein generally related to systems and methods for using software (called client-side software herein) running on a desktop computer, mobile device, or other computer system to authenticate with and access data, update, or otherwise use any functionality provided by web services, e.g., REpresentational State Transfer (REST) services or Application Programming Interfaces (APIs).

A software action may be any process or collection of processes or operations implemented via software. Additional examples of processes include updating or editing data in a database, placing a product order, creating an opportunity business object, creating a business contact object, adding a revenue line to a business object, displaying data visualizations or analytics, triggering a sequence of processes, launching an enterprise software application, displaying a dialog box, implementing a step of a process-based software application and so on. The terms “software action” and “action” are employed interchangeably herein.

Certain embodiments discussed herein are particularly useful for enabling use of client-side spreadsheets, such as Microsoft Excel, to provide input (including bulk input and implementing bulk operations) to server-side process-based software applications, thereby launching/driving the process-based software applications.

A spreadsheet may be any software application, such as Microsoft Excel, or other spreadsheet, for facilitating organization and use of data via tables. Depending upon the context in which the term is used, a spreadsheet may also refer to a document produced by the software application, or may refer to a table shown in a UI display screen of the software application. Alternatively, the term worksheet may refer to particular tables or sections of a spreadsheet UI. A workbook may refer to a collection of one or more worksheets.

Although reference may be made to specific types of spreadsheet programs, e.g., Microsoft Excel, it should be apparent that features of the embodiments can be adapted for use with any suitable spreadsheet program.

A process-based software application may be any software application definable by one or more sequences of steps, also called software activities. A sequence of steps (e.g., as may be involved in an approval flow, for instance) of a process-based software application may be called a process flow. Process flows are often modeled and illustrated via swim lanes in a User Interface (UI) display screen. Process-based applications are often implemented via composite applications that may leverage different web services for different process steps.

Software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

For clarity, certain well-known components, such as the Internet, hard drives, processors, power supplies, routers, Internet Service Providers (ISPs), workflow orchestrators, process schedulers, identity management clouds, process clouds, certificate authorities, business process management systems, database management systems, middleware, and so on, are not necessarily explicitly called out in the figures. However, those skilled in the art with access to the present teachings will know which components to implement and how to implement them to meet the needs of a given implementation.

### Spreadsheet Interfaces Integrated with Web Services

In accordance with an embodiment, a client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

In accordance with various embodiments, the system can include or utilize some or all of the following features:
Integrated Workbook—a software application document that contains metadata that the software extension or add-in component can use to interact with a web service or integration environment, including a layout metadata that defines one or more graphical user interface layouts associated with the workbook. For example, in accordance with an embodiment, a workbook can be provided as a spreadsheet-type document.
Worksheet—a component of a workbook. For example, in accordance with an embodiment, a workbook can be provided as a spreadsheet-type document, and can include one or more worksheet tabs, each having one or more spreadsheets.
Business Object—a web service or other type of service or object, that can be provided within an integration environment and allows operations (e.g., GET, POST, PATCH, or DELETE operations) on a particular resource or object type. For example, in accordance with an embodiment, an expense reports object can be provided that allows operations to create or edit expense reports.
Layout—a binding of a business object to a worksheet, as defined by a workbook metadata, for purposes of allowing operations on the business object. For example, in accordance with an embodiment, a spreadsheet-type document can be associated with a table layout that operates as a binding that allows editing of invoices via a tabular invoice worksheet and an associated web service.

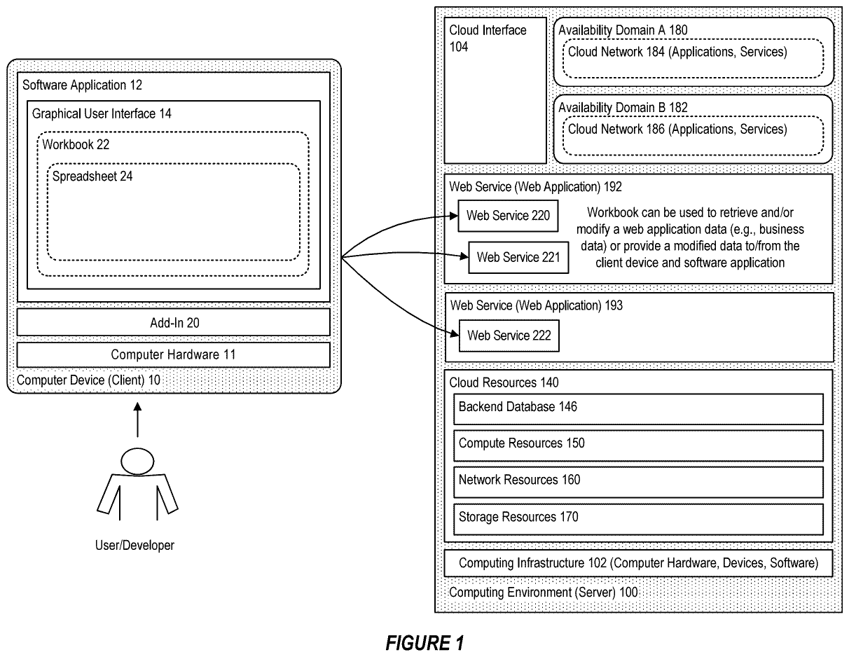

FIG. 1 illustrates a system for use of spreadsheets integrated with web services in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The examples illustrated therein are provided for purposes of illustrating a computing environment that can provide use of spreadsheets integrated with web services. In accordance with other embodiments, the various components, processes, and automated features described herein can be used with other types of computing environments.

As illustrated in FIG. 1 in accordance with an embodiment, a computing environment (e.g., a cloud environment, or server) 100 can operate on a computing infrastructure 102 comprising hardware (e.g., processor, memory), software resources, and provide a cloud interface 104 or other application program interface (API) that provides access to shared resources 140, such as, for example, a compute resources layer 150, a network resources layer 160, and/or a storage resources layer 170.

In accordance with an embodiment, the computing environment can support the use of availability domains, such as for example availability domains A 180, B 182, which enables customers to create and access cloud networks 184, 186, and run cloud instances.

In accordance with an embodiment, a client device, such as, for example, a computing device 10 having a device hardware 11 (e.g., processor, memory), a software application 12 (e.g., a spreadsheet application), and graphical user interface 14, can enable a user to communicate with the computing environment via network such as, for example, a wide area network, local area network, or the Internet, to access various applications, e.g., enterprise applications, including creating one or more workbook 22 or spreadsheet 24.

In accordance with an embodiment, web services 220, 221, 222 operate to receive requests directed to one or more web applications 192, 193.

For example, in accordance with an embodiment, a client device having a software application and graphical user interface can use a workbook or a software application document, for example a spreadsheet-type document, or other type of application document, to access a business object or web service to retrieve and/or provide a modified data to/from a web application.

In accordance with an embodiment, the web service can be, for example, a REST-based service, or other type of web service provided within an integration environment, that allows operations (e.g., GET, POST, PATCH, or DELETE operations) on a particular resource or object type (e.g., an expense reports object).

For example, in accordance with an embodiment, a business object can be provided and made accessible as a web service by an underlying service framework such as, for example, an Oracle REST Data Services environment, or a NetSuite environment, or other environment that allows client devices to communicate via web services and perform operations on associated business objects.

In accordance with an embodiment, a service-interface add-in 20 for use in software development can be provided, for example, as a software extension or add-in component, which operates both as a design tool, and as a runtime process, for purposes of integrating use of spreadsheets with web services.

In accordance with an embodiment, examples of software application environments can include spreadsheet-type software application or integration environments that can use workbooks, such as, for example, a Microsoft Excel or other type of spreadsheet-type software application.

In accordance with an embodiment, examples of software extension or add-in components can include, for example, an Oracle Visual Builder environment, configured as described herein, and which can be provided for use with a software application development environment, for purposes of developing workbooks.

In accordance with an embodiment, the workbook can be a software application document, for example a spreadsheet-type document, or other type of application document, that contains a catalog metadata that the software extension or add-in component can use to interact with a web service or other integration environment (for example, a REST-based service, or other type of web service), on behalf of a business user, together with a layout metadata that defines one or more graphical user interface layouts associated with the workbook.

In accordance with an embodiment, within a workbook, each layout provides a binding of a business object to a worksheet, as defined by a workbook metadata, for purposes of allowing operations on the business object, and integrating use of the spreadsheet with one or more web services.

In accordance with an embodiment, each workbook (e.g., spreadsheet-type document, or other type of software application document) can be considered a stand-alone application; with its only dependencies being its associated web service, the software application environment (e.g., a Microsoft Excel or other type of spreadsheet-type software application environment), and the software extension or add-in component.

In accordance with an embodiment, the add-in works directly with the web service to fetch and update data for the business user. Integrated workbooks are self-contained in that the required metadata is contained within the workbook, and can be distributed via various channels, for example via a Customer Connect channel, or embedded in web applications. Software application developers, information technology consultants, and customers can install the add-in, to design, create and test spreadsheet integrations directly on their desktop, with no dependency on another IDE or development environment.

In accordance with an embodiment, the layout forms a basis for integration of the web service (e.g., a business object) and the worksheet; and defines the aspects of the integration. For example, it can contain the set of desired table columns and their order; which of the available operations are enabled; or search/filter criteria used at data download time. A workbook can have multiple worksheets; and each worksheet can have a single layout.

In accordance with an embodiment, a client device can interrogate a web service to obtain web service metadata that determines one or more capabilities of that web service. For example, a client device 10 can send a request to a web service 220 requesting metadata, in response to which the web service can provide metadata describing which services, resources, or business objects that web service provides. The add-in can then use this information to configure a worksheet with a layout, for example to configure a spreadsheet-type document with a corresponding table component, based on the web service metadata. The table component can then be used to retrieve, display, edit, or communicate data within a spreadsheet, and upload user-made changes back to the web service.

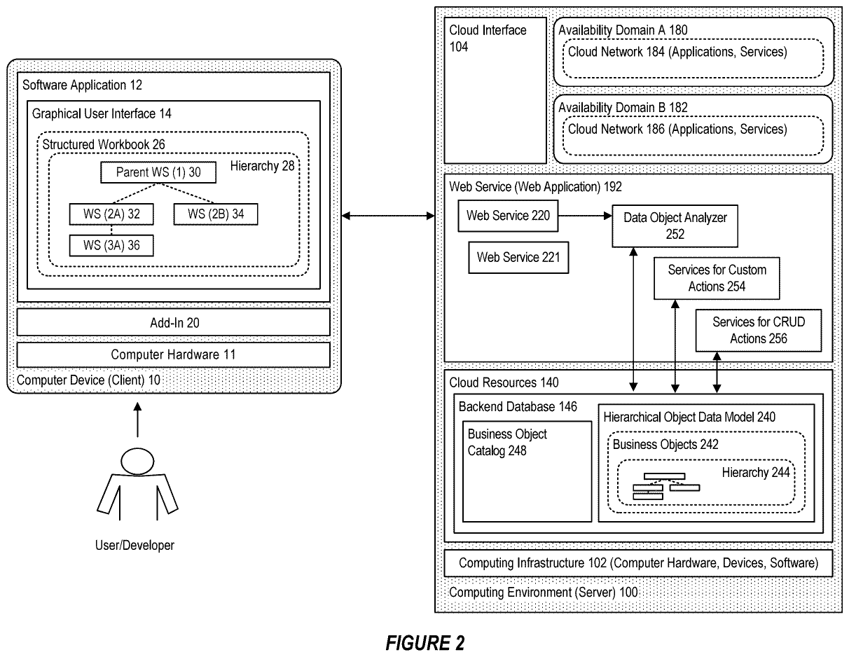

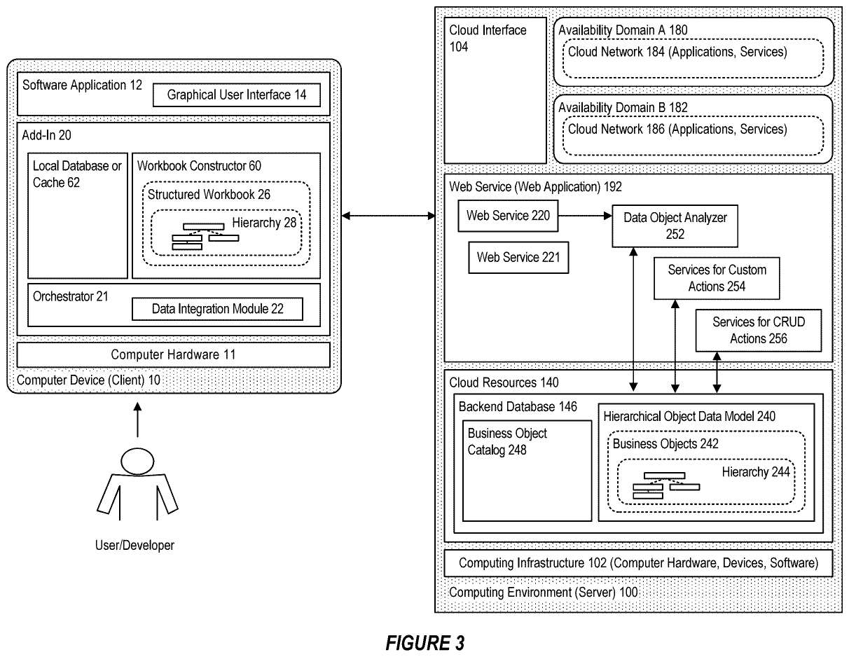

FIGS. 2 and 3 further illustrate a system for use of spreadsheets integrated with web services, including support for a hierarchical object data model, in accordance with an embodiment.

In accordance with an embodiment, FIG. 2 illustrates an example system and accompanying computing environment employing a client-side spreadsheet and accompanying service-interface add-in to interact with web services or Application Programming Interfaces (APIs) to facilitate operations, e.g., CRUD operations, on multi-dimensional hierarchically structured server-side data (e.g., corresponding to a hierarchical object data model 240) using a similarly multi-dimensional hierarchically related arrangement of spreadsheets (e.g., corresponding to a hierarchy of worksheets).

The example system includes one or more client systems (e.g., desktop computer, mobile device, etc.) in communication with a server system via a network, such as the Internet. The server system communicates with one or more backend databases 146. The server system runs one or more web services or APIs, which facilitate interaction between the one or more client systems and data and functionality maintained or provided via the backend databases.

The example client system(s) includes a spreadsheet (also called the client-side spreadsheet) with a service-interface add-in 20 and structured workbook 26.

The example web services (also called cloud-based services) of the server system include a data object analyzer 252, one or more services for facilitating implementing custom actions 254, and one or more services 256 for facilitating implementing CRUD operations.

The example backend databases include a business object catalog 248 and one or more hierarchical object data models (also called data structures herein).

Note that in general, groupings of various modules of the system are illustrative and may vary, e.g., certain modules may be combined with other modules or implemented inside of other modules, or the modules may otherwise be distributed differently (than shown) among a network or within one or more computing devices or virtual machines, without departing from the scope of the present teachings. For example, while the backend databases are shown separately from the server system, the backend databases may be part of the server system, without departing from the scope of the present teachings.

For instance, while the business object catalog and hierarchical object models may be implemented by a relational database that is used for persistence of the hierarchical object data models and accompanying data, other embodiments are possible. For instance the business object catalog hierarchical object data models may be implemented in the server system, e.g., via one or more web services and/or APIs and/or other module in communication therewith.

For example, a separate box (i.e., separate from the web services or APIs) may represent a module that incorporates functionality for communicating with, managing, and/or exposing the business object catalog and accompanying hierarchical object data models to the one or more client systems. The backend database(s) may influence the hierarchy, but, alternatively, may be used only for storage of data. Accordingly, in this example case, the business object data models and accompanying hierarchies can be implemented, in whole or in part, via one or more modules running on the server system.

In the example embodiment, the backend databases include business objects 242 that are hierarchically related in accordance with the hierarchical object data model; graphically depicted here via a data hierarchy 244. For instance, a given parent object may have one or more child objects (called children), and the children may also have one or more child objects.

The client-side structured workbook of the spreadsheet has been configured with client-side hierarchy 28 of worksheets, including a parent worksheet (WS) 30, a first child worksheet (WS 2a) 32, a second child worksheet (WS 2b) 34, and a grandchild worksheet (WS 3a) 36. These worksheets of the structured workbook have been associated, related, or otherwise linked to each other to establish the client-side hierarchical structure.

Associations, relations, or links between the worksheets and construction of the worksheets can be automatic and/or manual. During automatic configuration, the service-interface add-in obtains or accesses information about the server-side hierarchical object data model and accompanying business objects and hierarchical relationship structure (also called server-side hierarchy herein).

The service-interface add-in may obtain this descriptive information describing the server-side hierarchy and associated business object model responsive to one or more request messages sent by the service-interface add-in to the data object analyzer.

The data object analyzer may be a service that selectively accesses a business object catalog, which contains descriptive information, e.g., descriptions of business object hierarchies and data models, of the backend databases. The descriptive information can include relationship keys describing, for instance, how each of the hierarchically related business objects are related to each other (e.g., parent object, child object, sibling object, grandchild object, and so on).

The data object analyzer then delivers a response message with the descriptive information to the service-interface add-in responsive to the request message issued therefrom. The service-interface add-in includes code for automatically constructing the structured workbook and generating the initial worksheets.

The worksheets are then related to each other so that the worksheet hierarchy models a portion of, e.g., a subset of, (or all of, depending upon a given implementation) server-side hierarchy. Hence, the structure of the worksheet hierarchy (also called client-side hierarchy herein) matches a portion of the structure that includes data objects with data corresponding to data of the worksheets at similar levels of the data structure 240.

Note that the service-interface add-in may include computer code for controlling certain UI functionality of the spreadsheet. For instance, during manual structuring of relationships among the worksheets, a user may access one or more menus for selecting parent worksheets for given worksheets, and so on.

The service-interface add-in may control the availability of certain user options in such menus. For instance, the service-interface add-in may reference knowledge of the server-side hierarchy 244 to ensure that inappropriate relationships between the worksheets are not established, i.e., menu options for such are not provided during a manual configuration mode.

Structuring relationships between the worksheets in accordance with the server-side hierarchy, which characterizes the hierarchically related business objects of the hierarchical object data model, facilitates consistent interaction, synchronization, orchestration, including CRUD operations, which can now readily be implemented across complex data object hierarchies via a user-friendly UI of the spreadsheet.

In accordance with an embodiment, FIG. 3 illustrates additional detail of the service-interface add-in of the spreadsheet of the example system and accompanying computing environment of FIG. 2.

In accordance with an embodiment, the example service-interface add-in includes an example workbook constructor module 60 in communication with the web services, and in particular, the data object analyzer thereof. The workbook constructor includes code for selectively calling the data analyzer to obtain information about the hierarchical object data model and accompanying hierarchically related business objects, in addition to information about the server-side hierarchy itself, including relationships between constituent objects and sub-objects thereof.

The data object analyzer may include code for checking the business object catalog for suitable descriptions of the hierarchical object data model, and then retrieving the descriptions, so as to fulfill requests for such descriptions (which may include relationship keys identifying and describing relationships between different objects of the hierarchical object data model issued by the client-side workbook constructor.

The descriptions of the objects of the hierarchical object data model and accompanying objects and hierarchies can then be stored in a local database or cache for use by the workbook constructor 60 when constructing the worksheet hierarchy for use with the structured workbook and accompanying spreadsheet program of FIG. 2.

When building the worksheet hierarchy, the workbook constructor uses the information describing the data model (e.g., as may be obtained from the data object analyzer and business object catalog, or as may be retrieved from the local database or cache if already stored there) to construct the worksheet hierarchy using descriptive parameters or attributes that establish hierarchical relationships between the worksheets, such that the spreadsheet hierarchy parallels or mimics a portion of the server-side hierarchy.

With reference to FIGS. 2 and 3, each of the different worksheets (30-36) may be associated with a corresponding server-side data object of the server-side hierarchically related business objects. For instance, during workbook construction by the workbook constructor, the parent worksheet and data therein may correspond to a parent object of the hierarchically related business objects. Similarly, the first child worksheet may correspond to a first child object of the parent object of the hierarchically related business objects.

The service-interface add-in includes an orchestrator module and accompanying data integration module 22. The example orchestrator 21 includes code for facilitating implementation of orchestration of operations, e.g., CRUD operations, data synchronizations, implementation of custom actions (e.g., using data/parameters input from the spreadsheet), and so on, between the client-side spreadsheet and the server-side hierarchical object data model, via strategic use of the web services.

Furthermore, in the example embodiment, the orchestrator module of the service-interface add-in communicates with the local database or cache 62 and the workbook constructor. The orchestrator includes code for performing various functions, such as determining any changes or scheduled actions to any portions of the worksheets of the worksheet hierarchy; then determining when a user has selected to implement the changes (e.g., by detecting selection of an upload button); then traversing the worksheet hierarchy to package proposed changes, actions, operations, etc. into one or more request messages.

The one or more request messages are then sent to the web services, e.g., to the one or more services for implementing CRUD operations, and/or to the one or more services for implementing custom actions.

The request messages sent from the orchestrator and accompanying data integration module to the web services may include descriptive information indicating to the web services, which particular level and which particular business objects of the server-side hierarchy is/are to be operated on in accordance with the one or more request messages issued by the orchestrator and/or accompanying data integration module.

The web services may return status information, e.g., indicating whether or not a particular operation or action was successfully completed or not. This status information may then be subsequently displayed in the workbook and associated spreadsheets (30-36).

The orchestrator may also access the local database or cache to determine descriptive information of the server-side hierarchically related business objects and the client-side hierarchy of worksheets, and may then use that descriptive information to facilitate selectively updating the workbook and accompanying worksheets.

For instance, if the orchestrator determines that a user would like to download data for a parent worksheet, in response to user selection of a download button, the orchestrator may determine that the parent worksheet represents a parent node worksheet. Accordingly, when issuing a request message to the services for CRUD operations, the request message issued by the orchestrator may include descriptive information specifying retrieval of data from the corresponding parent data object of the server-side hierarchy.

Also note that in certain embodiments, if a given workbook includes worksheets that have not yet been populated with data, user selection of a download button may populate all of the worksheets with corresponding data from the hierarchical object data model, and data from different objects of that object data model will be positioned into corresponding worksheets at the corresponding hierarchical level.

### Multi-Level Business Objects

As described above, in accordance with an embodiment, the system can access a business object catalog, which contains descriptive information, e.g., descriptions of business object hierarchies and data models, of the backend databases. The descriptive information can include relationship keys describing, for instance, how each of the hierarchically related business objects are related to each other (e.g., parent object, child object, sibling object, grandchild object, and so on).

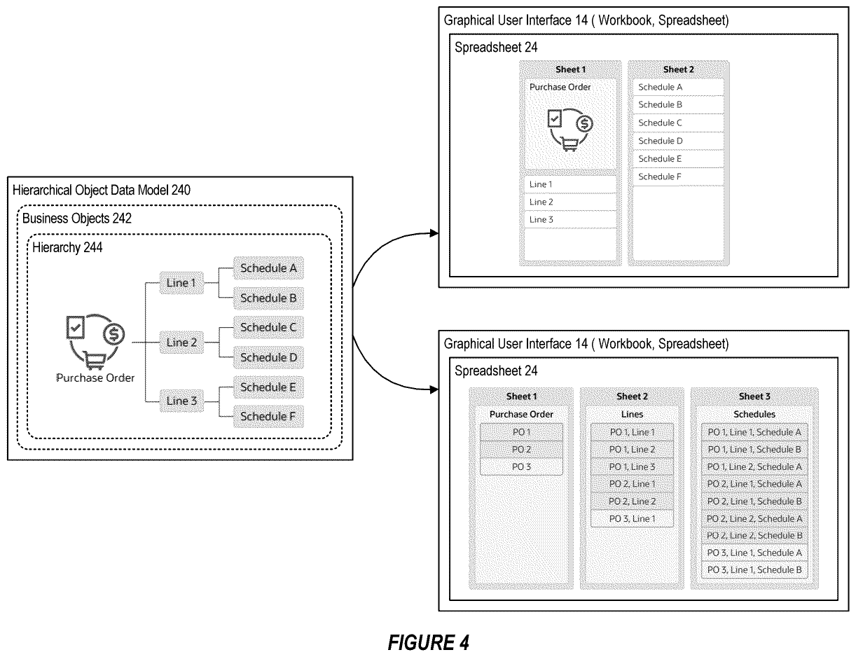

By way of example, FIG. 4 illustrates an example hierarchy of business objects, in accordance with an embodiment, where in this example the “Purchase Order” business objects are parents, the “Lines” business objects are children, and the “Schedules” business objects are grandchildren.

In this example business object hierarchy, Purchase Orders operates as a collection of top-level purchase orders, each with one or more Lines for managing the details of each order, wherein each of the Lines may include one or more Schedules for tracking shipping details.

A user can configure a set of dependent layouts, for example by creating either a Form-over-Table or a Table layout as a top-level or primary layout on a first worksheet, and Table layouts for each subordinate level on separate worksheets. For example, if the user wants to show a single purchase order and all its associated lines and schedules, they can create a Form-over-Table layout for the first two levels (Purchase Orders and Lines) and a Table layout for the third level (Schedules), and then configure a search to prompt for entry of a purchase order ID.

When the layouts are populated, the form part of the Form-over-Table layout displays details for the Purchase Order, while the table part displays the Lines for the purchase order, and the dependent Table layout displays of the Schedules for the associated lines.

When a Table layout is used instead, the system creates Table layouts for each level in the hierarchy (i.e., in this example, Purchase Orders, Lines, and Schedules) on separate worksheets. In this configuration, the spreadsheet can display one or more purchase orders in the primary Table layout, and the associated lines and schedules in the subsequent Table layouts.

### Creation of Child Rows in Child Spreadsheets

However, the process for creating child rows in such environments is often complicated and tedious, typically requiring the user to examine each child layout, check if the child layout can create child rows, insert new rows on the child layout manually, and switch back-and-forth between a parent layout and the child layout to insert ancestor values indicative of the hierarchical relationship.

Such a process generally requires the user to retain within their memory several spreadsheet values, spanning multiple layouts, and can result in errors. For example, if any ancestor value is wrong, the child row creation will fail.

In accordance with an embodiment, the described approach simplifies the process of creating child rows, where the work as generally outlined above can be performed substantially within the parent layout, and automatically by the system in response to user input, resulting in less repetitive work on the part of the user.

In accordance with an embodiment, the system leverages service metadata to detect eligible child layouts to create child rows. In addition, configuration can be provide by way of a wizard, with the add-in automatically performing the work of appending child rows and populating ancestor values in child layouts based on the configuration.

In accordance with various embodiments, the system can include or utilize some or all of the following features:
Child—in dependent layouts hierarchy, any second-level and lower level spreadsheets can be called a child.
Ancestors—for a child layout, its ancestors are defined as the spreadsheets reachable by a repeated proceeding from child to parent.

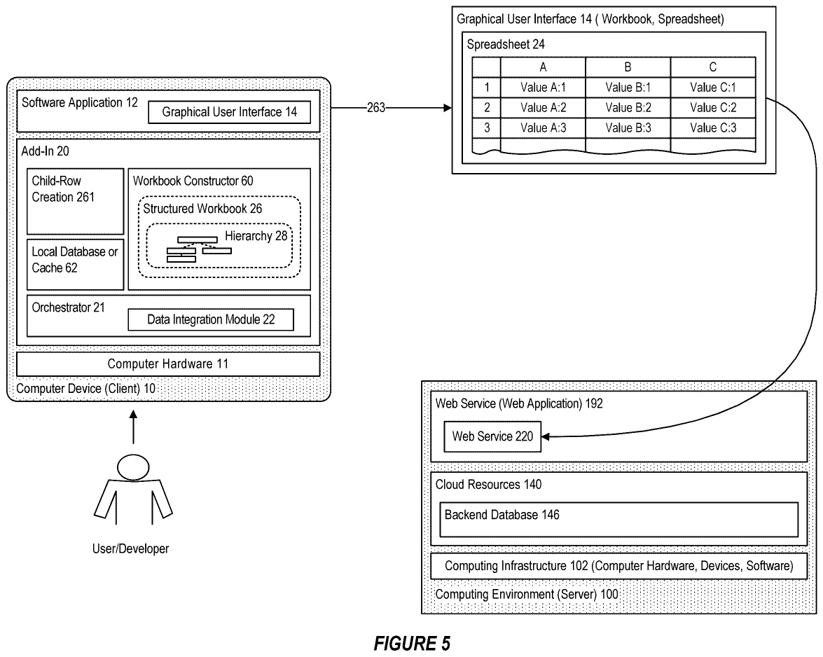

FIGS. 5-7 illustrate a system for creation of child rows in child spreadsheets, in accordance with an embodiment.

As illustrated in FIG. 5, and as described above, in accordance with an embodiment, a client device can include a service-interface add-in, for example, as a software extension or add-in component, which operates both as a design tool, and as a runtime process, for purposes of integrating use of spreadsheets with web services.

As also described above, in accordance with an embodiment, the client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

In accordance with an embodiment, the add-in can include a child row creation component 261, that provides support for creation of child rows in child spreadsheets, as further described herein.

In accordance with an embodiment, a workbook or a software application document, for example a spreadsheet-type document, or other type of application document, can be used 263 to access a business object or web service to retrieve and/or provide a modified data to/from a web application.

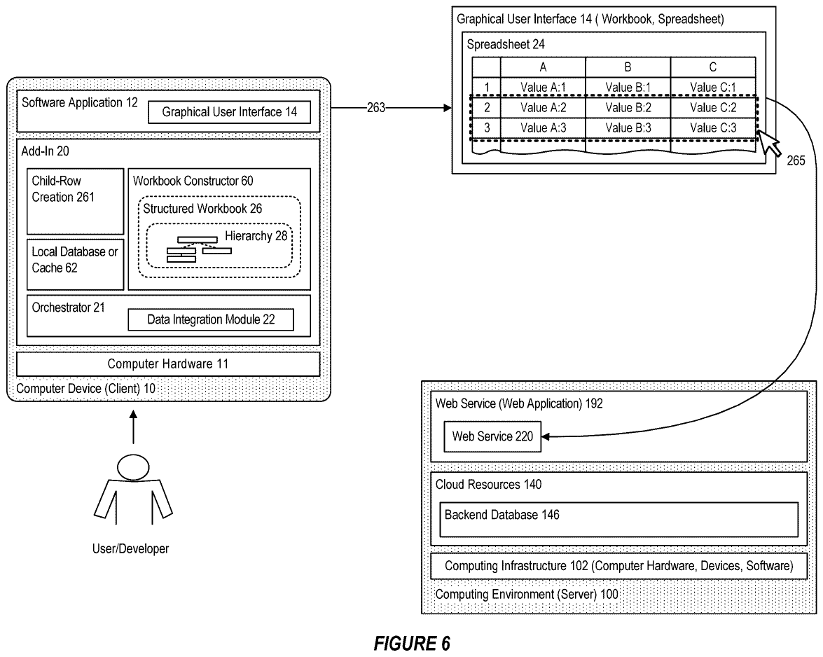

As illustrated in FIG. 6, in accordance with an embodiment, the child row creation component can operate in the manner of a wizard or helper application to generate or provide a user interface that allows the user to select 265 one or more rows of data, within a worksheet or spreadsheet, as a parent layout or rows, for use in creating child rows.

In accordance with an embodiment, based on the layout metadata that defines the layouts associated with the workbook, the system can maintain an understanding of the relationship between worksheet layouts, and provide the user interface with selectable options as to available child rows.

In accordance with an embodiment, the user can provide input or otherwise specify how many child rows should be created, for each of the one or more parent layout or rows that have been selected.

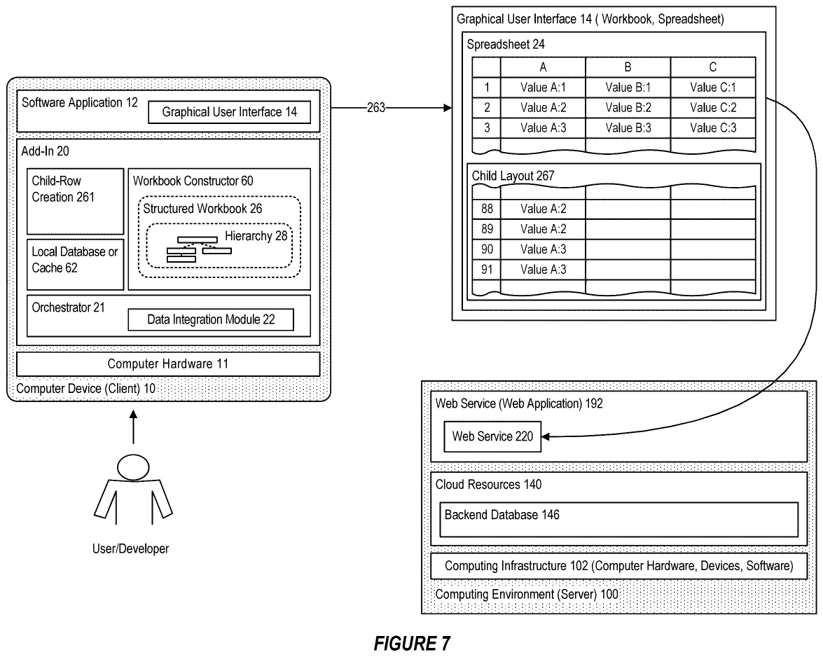

As illustrated in FIG. 7, in accordance with an embodiment, the child row creation component can then activate a child layout 267 with one or more appended child rows as requested by the user, including automatically selecting the first editable cell in the first child row and populating ancestor values indicative of the hierarchical relationship.

In accordance with an embodiment, selecting, by the user, a parent layout or rows, from which the system should create the child row, is then used by the system to populate the ancestor value.

In FIG. 7, for example, the values of the parent ancestor column (in this example, the A column) are automatically populated in the created child rows, to indicate the hierarchical relationship between the layouts, including that two child rows are created as children for parent layout or row A2: and two child rows are created as children for parent layout or row A:2.

Although for purposes of illustration, FIG. 7 generally illustrates an example wherein the child layouts are shown together in the user interface with the parent spreadsheet, and along with the created child rows, in practice the child layouts and the created child rows may be created and displayed, for example, in different areas or tabs of a multi-tab workbook or worksheet, depending on the system and the preference of the user.

In accordance with an embodiment, the child row creation component can operate to create multiple child rows within child layouts for multiple parent layouts or rows.

In accordance with an embodiment, the described approach can be similarly used with additional hierarchy members, including, for example, to create child rows for use with grandparent or grandchildren layouts.

### Example Use

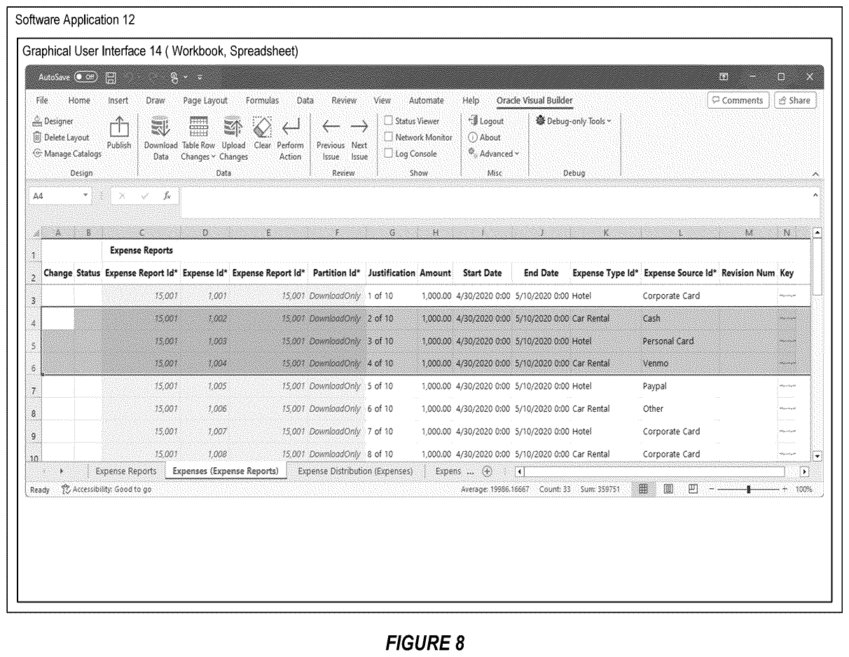

FIGS. 8-13 illustrate an example use of the system to create child rows in child spreadsheets, in accordance with an embodiment. As illustrated, the above-described approach can be used with a three-nested business object hierarchy:
Expense Reports
   →Expenses
      →Expense Distribution
      →Expense Itemizations

Wherein:

Expense Reports: a top-level of resource that contains a list of expense reports. Each expense report has information such as reporter and final approval date.

Expenses: a child resource of Expense Reports.

Expense Itemizations: a child resource of Expenses.

Expense Distribution: a child resource of Expenses.

As illustrated in FIG. 8, in a parent spreadsheet, the user can select rows to create child rows on. For example, in the illustrated example, the use has selected three rows in the “Expenses” layout for child row creation.

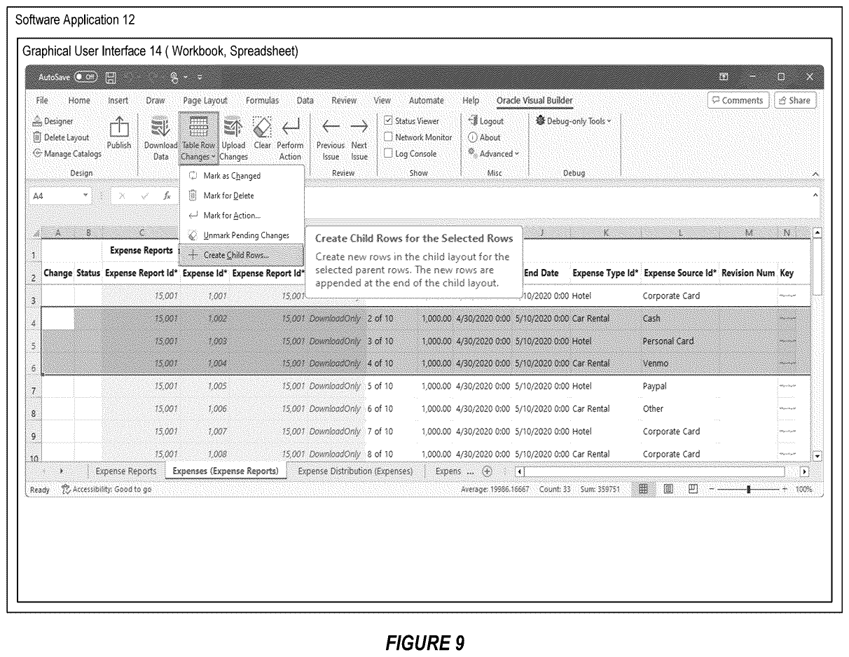

As illustrated in FIG. 9, the system provides wizard interface that allows a user to select a “Create Child Rows” button to bring up the wizard for configuration.

In accordance with an embodiment, the user can provide an input or otherwise specify how many child rows should be created, for each of the one or more parent layout or rows that have been selected.

In the illustrated example, the user has specified “Expenses” as the parent layout or row, and the system then provides the user interface with selectable options of “Expense Distributions” and “Expense Itemizations” as available child layouts or child rows, for further selection by the user.

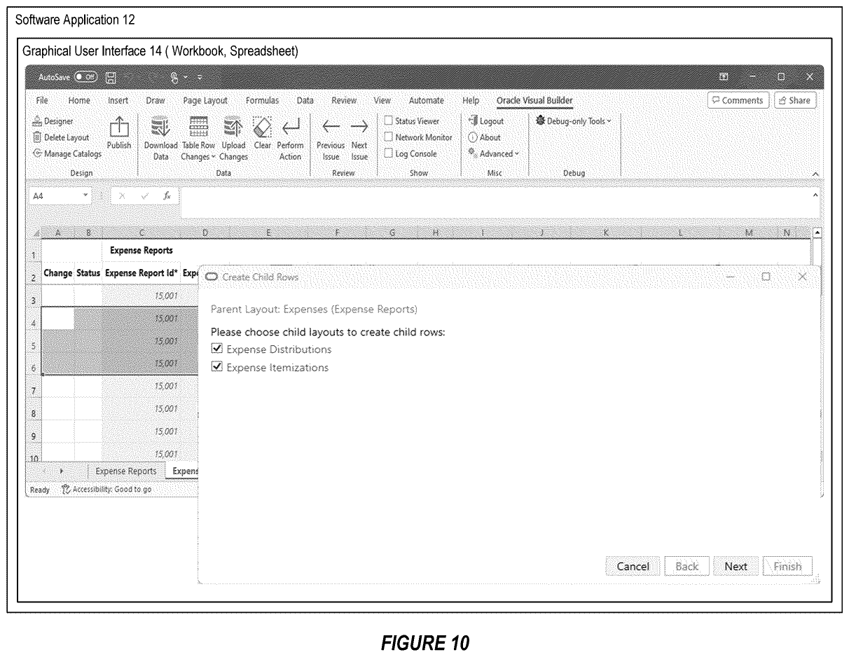

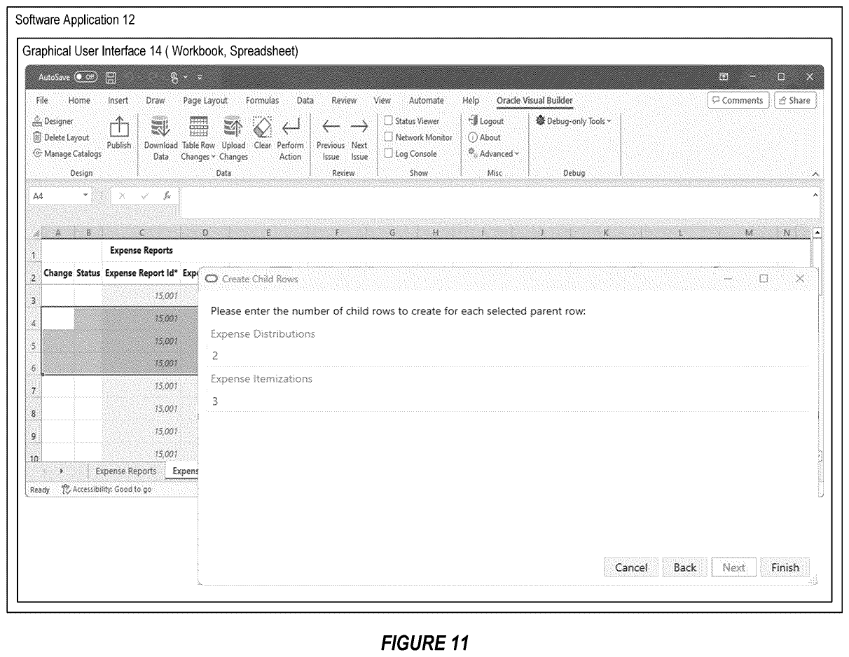

As illustrated in FIGS. 10 and 11, the system provides a user interface that allows a user to select child layouts, and provide input as to a number of child rows to create for each selected parent layout or row; and, responsive to said input, activate a child layout with appended child rows, including populated ancestor values.

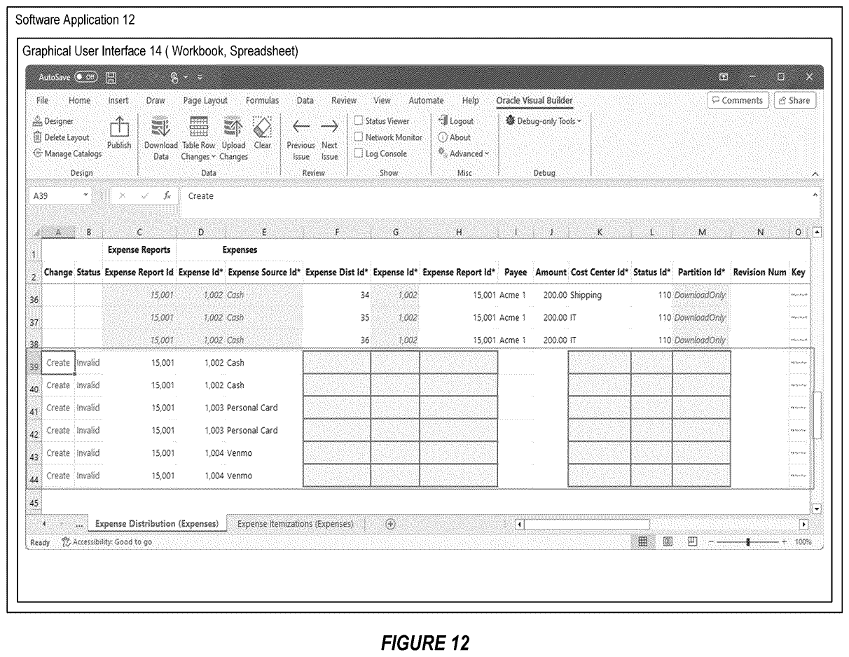

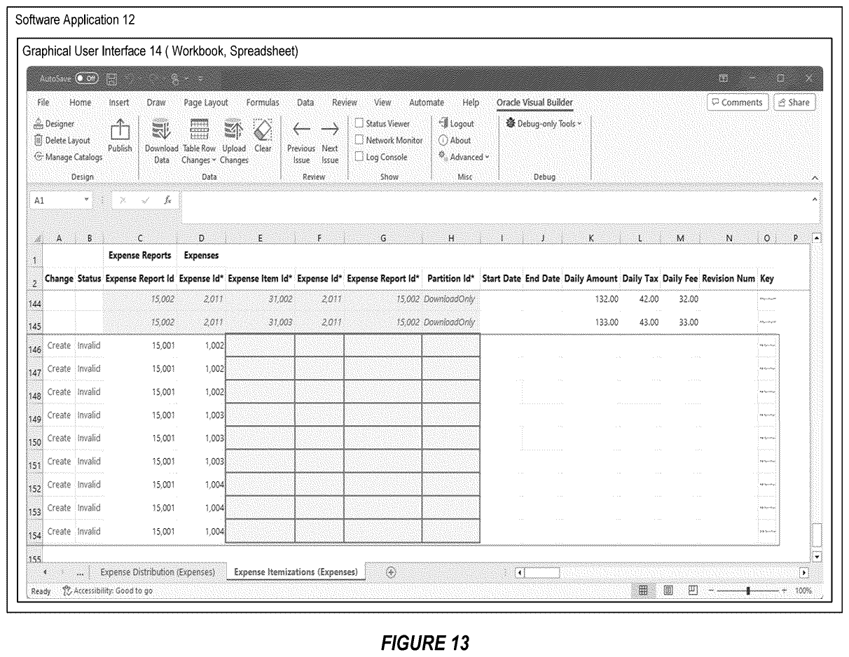

As illustrated in FIGS. 12 and 13, in response to the user input, the child row creation component creates new child rows in the child layout. Here, several child rows are automatically created by the system for the three originally-selected parent layout or rows, responsive to the user request.

In accordance with an embodiment, selecting a parent layout or rows, from which the system should create the child row, is used by the system to populate the ancestor value.

In the illustrated example, the system creates two child rows of a first type (e.g., Expense Distributions”, and three child rows of a second child type (e.g., “Expense Itemizations”) to reflect the user's input.

In the illustrated example, the ancestor values of 15,001 and 15,002 are obtained by the child row creation component from the originally-selected parent layout or rows. Selecting a parent layout or rows, from which the system should create the child row, is used by the system to populate the ancestor value (here, the Expense Report ID).

In accordance with an embodiment, the system can automatically switch between the presentation of the child layouts to allow the user to continue to edit the layouts, including enter required values, etc.

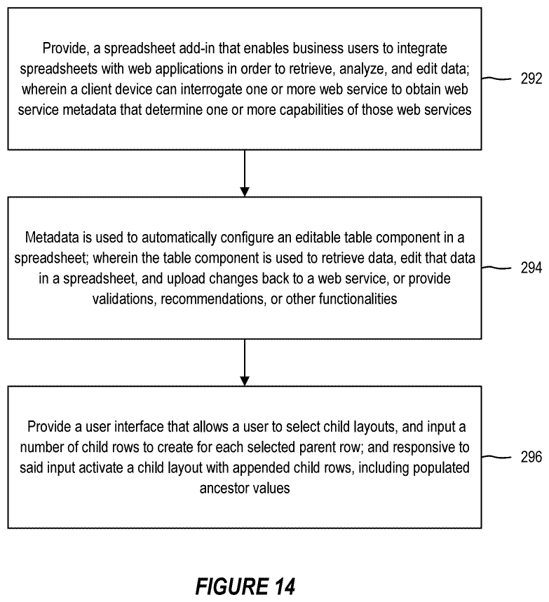

FIG. 14 illustrates a process for creation of child rows, in accordance with an embodiment.

As illustrated in FIG. 14, in accordance with an embodiment, the process or method comprises, at step 292, providing a spreadsheet add-in that enables business users to integrate spreadsheets with web applications in order to retrieve, analyze, and edit data; wherein a client device can interrogate one or more web services to obtain web service metadata that determines one or more capabilities of those web services.

At step 294, metadata is used to automatically configure an editable table component in a spreadsheet; wherein the table component is used to retrieve data, edit that data in a spreadsheet, and upload changes back to a web service, or provide validations, recommendations, or other functionalities.

At step 296, the system provides a user interface that allows a user to select child layouts, and input a number of child rows to create for each selected parent layout or row; and responsive to said input activate a child layout with appended child rows, including populated ancestor values.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for use of spreadsheets integrated with web services, including support for creation of child rows in child spreadsheets, comprising:
a client device operable to interrogate one or more web services to obtain web service metadata that determines one or more capabilities of those web services;
wherein the metadata is used to automatically configure an editable table component in a spreadsheet, wherein the table component is used to retrieve data, edit the data in the spreadsheet, or upload changes back to the web service, or provide validations, recommendations, or other functionalities;
wherein the system provides a user interface that allows a user to select child layouts, and input a number of child rows to create for each selected parent layout or row, and responsive to said input, activate a child layout with appended child rows, including populated ancestor values.

2. The system of claim 1, wherein the system can access a business object catalog, which contains descriptive information of business object hierarchies and data models, including relationship keys describing how hierarchically related business objects are related to each other.

3. The system of claim 1, further comprising a child row creation component that operates in the manner of a wizard or helper application to generate or provide a user interface that allows the user to select one or more rows of data, within a worksheet or spreadsheet, as a parent layout or rows, for use in creating child rows.

4. The system of claim 1, wherein based on a layout metadata that defines layouts associated with a workbook, the system
maintains an understanding of the relationship between worksheet layouts, and provides the user interface with selectable options as to available child layouts;
receives a user input that specifies how many child rows should be created, for each of the one or more parent layout or rows that have been selected; and
activates a child layout with one or more appended child rows, including automatically populating ancestor values indicative of the hierarchical relationship.

5. The system of claim 1, wherein the system is provided as part of a cloud computing system.

6. A method for use of spreadsheets integrated with web services, including support for creation of child rows in child spreadsheets, comprising:
providing a client device operable to interrogate one or more web services to obtain web service metadata that determines one or more capabilities of those web services;
wherein the metadata is used to automatically configure an editable table component in a spreadsheet, wherein the table component is used to retrieve data, edit the data in the spreadsheet, or upload changes back to the web service, or provide validations, recommendations, or other functionalities;
wherein the system provides a user interface that allows a user to select child layouts, and input a number of child rows to create for each selected parent layout or row, and responsive to said input, activate a child layout with appended child rows, including populated ancestor values.

7. The method of claim 6, wherein the system can access a business object catalog, which contains descriptive information of business object hierarchies and data models, including relationship keys describing how hierarchically related business objects are related to each other.

8. The method of claim 6, further comprising a child row creation component that operates in the manner of a wizard or helper application to generate or provide a user interface that allows the user to select one or more rows of data, within a worksheet or spreadsheet, as a parent layout or rows, for use in creating child rows.

9. The method of claim 6, wherein based on a layout metadata that defines layouts associated with a workbook, the system
maintains an understanding of the relationship between worksheet layouts, and provides the user interface with selectable options as to available child layouts;
receives a user input that specifies how many child rows should be created, for each of the one or more parent layout or rows that have been selected; and
activates a child layout with one or more appended child rows, including automatically populating ancestor values indicative of the hierarchical relationship.

10. The method of claim 6, wherein the method is performed within a cloud computing system.

11. A non-transitory computer readable storage medium having instructions thereon, which when read and executed by a computer cause the computer to perform a method comprising:
providing a client device operable to interrogate one or more web services to obtain web service metadata that determines one or more capabilities of those web services;
wherein the metadata is used to automatically configure an editable table component in a spreadsheet, wherein the table component is used to retrieve data, edit the data in the spreadsheet, or upload changes back to the web service, or provide validations, recommendations, or other functionalities;
wherein the system provides a user interface that allows a user to select child layouts, and input a number of child rows to create for each selected parent layout or row, and responsive to said input, activate a child layout with appended child rows, including populated ancestor values.

12. The non-transitory computer readable storage medium of claim 11, wherein the system can access a business object catalog, which contains descriptive information of business object hierarchies and data models, including relationship keys describing how hierarchically related business objects are related to each other.

13. The non-transitory computer readable storage medium of claim 11, further comprising a child row creation component that operates in the manner of a wizard or helper application to generate or provide a user interface that allows the user to select one or more rows of data, within a worksheet or spreadsheet, as a parent layout or rows, for use in creating child rows.

14. The non-transitory computer readable storage medium of claim 11, wherein based on a layout metadata that defines layouts associated with a workbook, the system
maintains an understanding of the relationship between worksheet layouts, and provides the user interface with selectable options as to available child layouts;
receives a user input that specifies how many child rows should be created, for each of the one or more parent layout or rows that have been selected; and
activates a child layout with one or more appended child rows, including automatically populating ancestor values indicative of the hierarchical relationship.

15. The non-transitory computer readable storage medium of claim 11, wherein the method is performed within a cloud computing system.
